(19) United States
(12) Patent Application Publication
(10) Pub. No.: US 2025/0106047 A1
(43) Pub. Date: Mar. 27, 2025

(54) Covert Cholesteric Liquid Crystal Reflectors

(71) Applicant: Université du Luxembourg, Esch-sur-Alzette (LU)

(72) Inventors: Jan Lagerwall, Esch-sur-Alzette (LU); Hakam Agha, Esch-sur-Alzette (LU); Rijeesh Kizhakidathazhath, Esch-sur-Alzette (LU)

(21) Appl. No.: 18/728,174

(22) PCT Filed: Dec. 21, 2022
(86) PCT No.: PCT/EP2022/087164

§ 371 Date: Jul. 11, 2024

(30) Foreign Application Priority Data
Jan. 13, 2022 (LU) LU501247

(51) Int. Cl. H04L 9/32; G02B 5/30; G09C 1/00

(52) U.S. Cl. CPC H04L 9/3278; G02B 5/3016; G09C 1/00

(57) ABSTRACT

An article having a decor provided by one or more exposed layers is disclosed. The article comprises a tag integrated in the one or more exposed layers yet camouflaged in the decor to the naked human eye, the tag comprising an arrangement of spherical cholesteric liquid crystal reflectors. In addition, methods for providing an authenticable article and for authenticating an article as well as a communication method are disclosed.

### FIELD OF THE INVENTION

The invention generally relates to articles comprising a tag including an arrangement of cholesteric liquid crystal reflectors.

### Acknowledgment

The project leading to this application has received funding from the following organisations: European Research Council (ERC) under the European Union's Horizon 2020 research and innovation programme (grant agreement No 648763), University of Luxembourg (project UNIQUE), FNR CORE project SSh, grant code C17/MS/11688643/SSh/Lagerwall) and Office of Naval Research Global (ONRG) award number N62909-19-1-2093.” Project LAB′RINTH.

### BACKGROUND OF THE INVENTION

QR codes are all around us, and although they were initially intended to be only used for tracking parts along the manufacturing line, nowadays they are used over a wide range of applications. One important application is traceability and brand protection, where serialized QR codes help customers address any concerns they might have about the origin of the products, by simply scanning the code using their smartphones and acquire specific information about each ingredient constituting the products they are buying and its supply chain. Moreover, QR codes are being used as part of an authentication system by brands and governments, empowering the customer in the fight against counterfeiting. Other types of printed label may fulfil the same function such as serial numbers or bar-codes.

Nevertheless, the world is currently witnessing a scourge of problems caused by counterfeiting of products across all markets (textiles, electronics, mechanical parts, food, healthcare, medical devices, luxury goods, etc.) and of sub-standard or unsustainably produced components. As the supply chains are getting increasingly complex due to international outsourcing, plenty of opportunities are appearing for bad actors, from the use of counterfeit components or sub-standard raw materials in the production, to unethical manufacturing practices and product replacement during distribution. This can potentially be dangerous and create health and safety risks in industries like healthcare for example.

In their latest report on illicit trade, the OECD (OECD/EUIPO (2021), Global Trade in Fakes: A Worrying Threat, Illicit Trade, OECD Publishing, Paris, https://doi.org/10.1787/74c81154-en) estimates the 2019 volume of international trade in counterfeit and pirated products to as much as USD 464 billion, or 2.5% of world trade, and it is increasing in scope and magnitude.

The Bureau of International Labor Affairs (ILAB-https://www.dol.gov/agencies/ilab/resources/reports/child-labor) from the US Department of Labor shares an extensive set of reports documenting the atrocious presence of child and forced labour in the production of goods and services sold to consumers across the world, many of whom would be willing to pay more for a proof that no such labour was part of the production.

Therefore, the ability to authenticate and identify objects securely and reliably, thereby confirming their provenance and tracing their whereabouts throughout the supply chain is key.

As indicated above, printed labels such as serial numbers or QR-/bar-codes are the most common means used to track and trace a product, whether it is along the production line, or supply chain, and at the same time act as an identifier for authenticity. Such solutions are prevalent because they are cost effective and easy to deploy. It is the simplest overt solution that can empower the consumer with a modern smartphone and enable them to compare the code identifier against a remote database, verify the supply chain integrity and be able to authenticate the product or report the existence of non-compliance. However, a regular QR-code is as easy to clone as it is to print in the first place, hence an authentication method based on standard QR-code technology is not trustworthy. More sophisticated QR codes have therefore been developed (see e.g. U.S. Pat. No. 9,594,993 B2), promising a high security level based on naturally occurring degradation during the printing process.

Electronics-based solutions are also becoming more common, in particular those based on Radio Frequency Identification (RFID) technology. RFID tags are typically stuck or embedded in products and function by memorizing data, typically a unique identifier ID, and releasing it when queried by a reader. More advanced labels (see e.g. https://op.europa.eu/s/qzMG), such as holograms, optical variable devices (OVD), watermarks, security threads, and florescence artifacts are also being used. The requirement of special expertise and equipment to make these labels make them rather suited for authentication, but as they are not unique, they lack the track and trace features. They can be combined with a QR code image, making a multi-layered authentication that combines visual images embedded with unique codes, encrypted data and variable holograms, but they still exhibit characteristic features that make them easy to recognize as a legitimate label of this type.

Significant activity has thus started in developing unique and uncloneable labels, typically of PUF (Physical unclonable function) type, where the label exhibits features that are unique, cannot be cloned, and has the property of reacting to a challenge generating a unique response. Several technologies are under development or on the market, but none has yet been widely adopted. See Chong, C. N., Jiang, D., Zhang, J., & Guo, L. (2008). Anti-counterfeiting with a random pattern. Proceedings-2nd Int. Conf. Emerging Security Inf., Systems and Technologies, SECURWARE 2008, Includes DEPEND 2008: 1st Int. Workshop on Dependability and Security in Complex and Critical Inf. Sys., 10, 146-153. https://doi.org/10.1109/SECURWARE.2008.12; R. Arppe and T. J. Sørensen, Physical unclonable functions generated through chemical methods for anti-counterfeiting, Nature Reviews Chemistry 1, 0031, 1 (2017); Liu, Y., Han, F., Li, F., Zhao, Y., Chen, M., Xu, Z., Zheng, X., Hu, H., Yao, J., Guo, T., Lin, W., Zheng, Y., You, B., Liu, P., Li, Y., & Qian, L. (2019). Inkjet-printed unclonable quantum dot fluorescent anti-counterfeiting labels with artificial intelligence authentication. Nature Communications, 10(1), 1-9. https://doi.org/10.1038/s41467-019-10406-7.

The key drawback of the most common serialization tools like the QR-/bar-codes, and serial numbers, is that they can easily be cloned, hence a counterfeit product or an unsustainably produced item can be given the same label as a genuine and sustainably produced item. The same holds for RFID chips, as the content can be read by someone equipped with an RFID reader. While more advanced active RFID tags with implemented cryptographic algorithms are nowadays available, they come at a high price tag compared to the passive RFIDs. Modern packaging design often features bar- or QR-codes, but they are generally on the back of the product, away from customers' view, but also from convenient scanning opportunities by electronic devices while they are in the shelf.

Clonability is also an issue for the advanced labels without PUF characteristics, such as holograms, OVDs, and water marks, even if more advanced equipment and know-how is needed; what one person can do, another one can copy. By infiltrating the company producing the labels, a bad actor can gain access to making copies also of such advanced serialization labels. An example is the sophisticated security features that are incorporated in banknotes, and yet they are being counterfeited.

While PUF tags by definition cannot be cloned, their main drawbacks are expensive and complicated read-out (e.g. for DNA—or radioactive material—based PUFs) and lack of robustness due to sensitivity to noise (e.g. for PUFs based on random laser speckle patterns) or risk of uncontrolled changes to the tag (e.g., dirt being added to or pigment being removed from authentication technologies relying on high-resolution optical analysis of regular printed QR-/bar-codes).

### General Description

An aspect of the invention relates to an article having a décor provided by one or more exposed layers, comprising a tag integrated in the one or more exposed layers yet camouflaged in the décor to the naked human eye, the tag comprising an arrangement of cholesteric liquid crystal spherical reflectors.

As used herein, a “décor” designates a decorative motif. The décor is formed by one or more layers that are exposed (i.e. visually inspectable by the naked eye under ambient light), when looking at the article. The décor may be provided by one or more visible layers. The layers are visible in the sense that they reflect one or more colours in the visible spectrum (i.e. from (about) 380 nm to (about) 750 nm) under ambient light. In addition, the décor may also comprise one or more transparent layers (e.g. a varnish). It will be appreciated that the decorative motif may comprise two- and/or three-dimensional decorative features.

As used herein, a “liquid crystal” is a state of matter which has properties between those of conventional liquids and those of solid crystals. In other words, a liquid crystal can flow like a liquid but has some degree of ordering in the arrangement of its molecules.

As used herein, a “cholesteric liquid crystal” (also called chiral nematic liquid crystal) is a liquid crystal that exhibits a helical twisting of its molecules along an axis perpendicular to the preferred orientation of the molecules. In cholesteric liquid crystals, the helical modulation of the refractive index (due to the preferential molecular alignment direction rotating in the helical structure) gives rise to selective (Bragg) reflection of light in a narrow wavelength band (hereinafter referred to as “peak wavelength” for the sake of simplicity), the central wavelength (in air) of which is determined by the pitch of the helix, the average refractive index of the liquid crystal and the angle of incidence of the light. The average refractive index of the liquid crystal is the one experienced by light reflected by the helix (E. Priestley. “Introduction to Liquid Crystals” (Ed: E. Priestley), Springer, Berlin, 1975, 203-218). The reflected light is circularly polarized with the same handedness as the cholesteric helix (left or right).

“Cholesteric liquid crystal reflectors” are objects based on cholesteric liquid crystals providing the selective (Bragg) reflection as disclosed above.

The article may be a painting, a printed image, a logo, a box, a pharmaceutical packaging, a bottle closure, a wall, a ceiling, a floor, etc.

It will be appreciated that the tag as defined above provides blends in the décor of the article as it is camouflaged. It directly follows that, in contrast to common QR codes, the tag doesn't compromise the décor of the article. The use of an arrangement of cholesteric liquid crystal reflectors allows for providing a fingerprint to the article that can be probed by incident light.

In a preferred embodiment, the arrangement of cholesteric liquid crystal reflectors provides a physical unclonable function (PUF), thereby providing a unique fingerprint to the article. A PUF is a physical entity embodied in a physical structure, here the décor which is provided by the one or more exposed layers. A PUF is embodied by physical object that for a given input and conditions (challenge), provides a physically defined unique fingerprint output (response) that serves as a unique identifier. In particular, the arrangement of cholesteric liquid crystal reflectors of the tag responds in an unpredictable (but repeatable) way due to the complex interaction of the stimulus with the physical microstructure of the reflectors.

Typically, the tag may cover an area comprised in the range from 0.1 cm² to 100 cm², preferably in the range of 0.5 cm² to 25 cm², even more preferably in the range of 1 cm² to 10 cm².

Also, the reflectors may have a size comprised in the range 5 μm to 500 μm, preferably in the range 10 μm to 350 μm, more preferably in the range 20 μm to 100 μm. The reflectors are of spherical shape, the diameter of which may be comprised in the range 5 μm to 500 μm, preferably in the range 10 μm to 350 μm, more preferably in the range 20 μm to 100 μm. Small deviations from perfect spheres are contemplated. For example, ellipsoids are also contemplated. The ellipsoids may have a linear eccentricity not greater than 2, preferably not greater than 1.5, even more preferably not greater than 1.25.

As used herein, the wording “spherical” in the context of reflectors may encompass said small deviations from perfect spheres.

Advantageously, the reflectors have a radial helix orientation.

The décor may include one or more coloured patches, each patch having a colour, wherein the cholesteric liquid crystal reflectors are localized in one or more of the coloured patches and wherein the cholesteric liquid crystal reflectors localized in a coloured patch are colour-matched with the colour of that coloured patch. The colour of the patches may be the same or different. It will be appreciated that the tag integrated in the one or more exposed layers is camouflaged in the décor to the naked human eye in that the colour of the reflectors is matched to the respective coloured patch.

In an embodiment, the cholesteric liquid crystal reflectors localized in a coloured patch are colour-matched with the colour of that coloured patch in that the cholesteric liquid crystal reflectors have a retroreflection peak wavelength corresponding to the colour of the coloured patch.

The cholesteric liquid crystal reflectors localized in a coloured patch may be colour-matched with the colour of that coloured patch in that a multiplicity of cholesteric liquid crystal reflectors having different retroreflection peak wavelengths is provided in that patch, the multiplicity being composed such that a mixture of the retroreflection peak wavelengths combines, to the naked human eye, into a colour corresponding to the colour of the coloured patch.

The cholesteric liquid crystal reflectors may be doped with a colorant so as to (at least partially) absorb reflections of the reflectors (preferably in the visible spectrum) that are blue shifted with respect to the reflectors respective retroreflection peaks.

The arrangement of cholesteric liquid crystal reflectors comprises at least two of: cholesteric liquid crystal reflectors having a retroreflection peak comprised in the range from 625 nm to 750 nm, comprised in the range from 500 nm to 565 nm and comprised in the range from 450 nm to 485 nm. The reflectors may be composed such that a mixture of the retroreflection peak wavelengths combines, to the naked human eye, into a colour corresponding to the colour of a coloured patch of the décor. For example, for a white patch, the mixture of reflectors may be composed of 1:1:1 proportion of the above three types of reflectors.

The arrangement of cholesteric liquid crystal reflectors comprises cholesteric liquid crystal reflectors having a retroreflection peak comprised outside of the visible spectrum, preferably in the range from 380 nm to 400 nm. It will be appreciated that reflectors having a retroreflection peak comprised outside of the visible spectrum are particularly suited for black patches of the décor.

The tag may comprise a binder in which the arrangement of cholesteric liquid crystal reflectors is embedded. The binder may be transparent or at least semi-transparent. It will be appreciated that this embodiment allows for affixing tags after production of the articles (e.g. old paintings).

The binder may have a melting temperature, the melting temperature being selected such that it is equal to a predefined maximal storing temperature of the article. It will be appreciated that the binder thereby allows for checking the storage temperature of articles e.g. during transport. By choosing a binder having a melting temperature equal to the maximal (predefined) storage temperature of an article, it is possible to check whether the article has been stored at a temperature above the maximal storage temperature. Indeed, the binder of the tag will melt thereby changing the arrangement of cholesteric liquid crystal reflectors. This may be of particular relevance for drugs having strict maximal storage temperatures.

The tag may comprise at least one of: a serialisation code e.g. a QR code or a barcode, and alphanumeric symbols.

A second aspect of the invention relates to an authenticable article, the authenticable article being an article as disclosed above, wherein an expected response of the arrangement of cholesteric liquid crystal reflectors of the tag with respect to an electromagnetic stimulus is stored in a database.

A third aspect of the present invention relates to a method for providing an authenticable article, comprising:
probing the tag of the article as disclosed above with an electromagnetic radiation;
sensing the tag electromagnetic response to the electromagnetic radiation; and
storing the sensed response (e.g. in a database).

The sensing of the tag may comprise taking two digital pictures, the first of the two digital pictures being obtained through a left-handed circular polarizer and the second of the two digital pictures being obtained through a right-handed circular polarizer, the storing of the sensed response comprises storing at least one of: both the digital images obtained through the left-handed circular polarizer and the right-handed circular polarizer and the difference between the digital images obtained through the left-handed circular polarizer and the right-handed circular polarizer.

A further aspect of the present invention relates to a method for authenticating an article as disclosed above, the method comprising:
probing the tag with an electromagnetic radiation;
sensing the electromagnetic response of the tag to the electromagnetic radiation; and
comparing the sensed response to an expected response, preferably stored in a database, so as to authenticate the sensed tag.

In the present document, “authenticating” an article corresponds to the process of verifying the article's identity. Authenticating an article may thus validate the identity of the article in case there is a match between the sensed response and the expected response or invalidate the identity of the article in case there is no match between the sensed response and the expected response.

The sensing of the tag may comprise taking two digital pictures of the tag, the first of the two digital pictures being obtained through a left-handed circular polarizer and the second of the two digital pictures being obtained through a right-handed circular polarizer, the comparison being carried out by comparing the respective two digital pictures, and/or a difference thereof, with the expected pictures, and/or difference thereof, preferably stored in the database, so as to authenticate the sensed tag.

A further aspect of the present invention relates to a communication method comprising:
retrieving, from a database, an expected electromagnetic response of the tag of the article as disclosed above to be authenticated;
comparing an electromagnetic response sensed from the tag of the article to be authenticated with the expected electromagnetic response so as to authenticate the sensed tag.

In the present document, the verb “to comprise” and the expression “to be comprised of” are used as open transitional phrases meaning “to include” or “to consist at least of”. Unless otherwise implied by context, the use of singular word form is intended to encompass the plural, except when the cardinal number “one” is used: “one” herein means “exactly one”. Ordinal numbers (“first”, “second”, etc.) are used herein to differentiate between different instances of a generic object; no particular order, importance or hierarchy is intended to be implied by the use of these expressions. Furthermore, when plural instances of an object are referred to by ordinal numbers, this does not necessarily mean that no other instances of that object are present (unless this follows clearly from context).

### BRIEF DESCRIPTION OF THE DRAWINGS

By way of example, preferred, non-limiting embodiments of the invention will now be described in detail with reference to the accompanying drawings, in which:

FIG. 1: shows the structure of chemical components used in the CLC precursor mixture;

FIG. 2: is a picture of R, G and B-CSRs in suspension (a), mixed in 1:1:1 proportion (b), and R, G and B-CSRs applied on a substrate (c);

FIG. 3: is a picture of orange doped CSRs on an orange background (a), and on a black background (b);

FIG. 4: illustrate a QR code made from a tag of CSRs matching the background colour of the ‘uni.lu’ logo; and

FIG. 5: shows the steps for detecting the tag comprising CSRs.

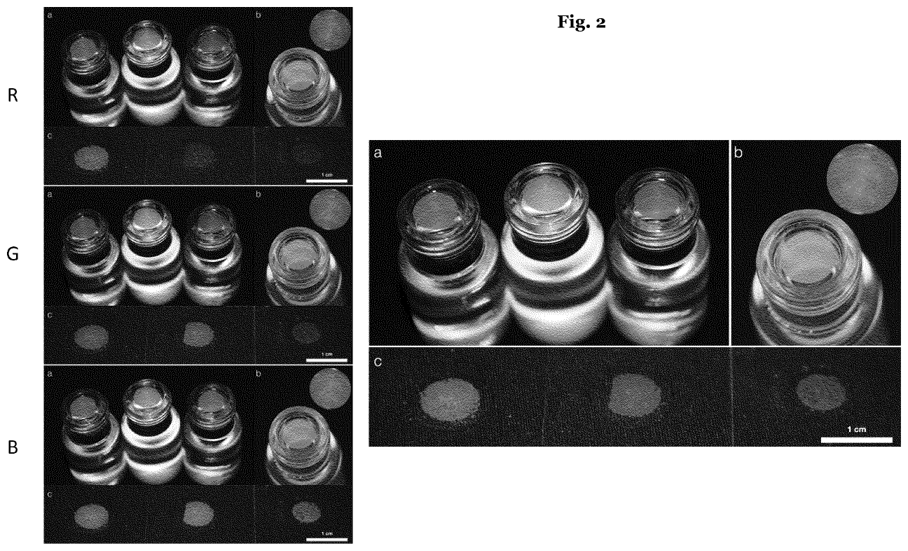

On the left hand side of FIGS. 2-5, the RGB decomposition of the (greyscaled) picture/drawing as shown on the right hand side is provided.

The reader's attention is drawn to the fact that the drawings are not to scale. Furthermore, for the sake of clarity, proportions between height, length and/or width may not have been represented correctly.

### DETAILED DESCRIPTION OF PREFERRED EMBODIMENTS OF THE INVENTION

The cholesteric liquid crystal reflectors (CSRs) are produced using a cholesteric liquid crystal (CLC) as a template. According to an embodiment, the CLC precursor mixture comprises (a blend of) reactive mesogens, a chiral dopant and a photo-initiator. The chiral dopant may be polymerizable or not.

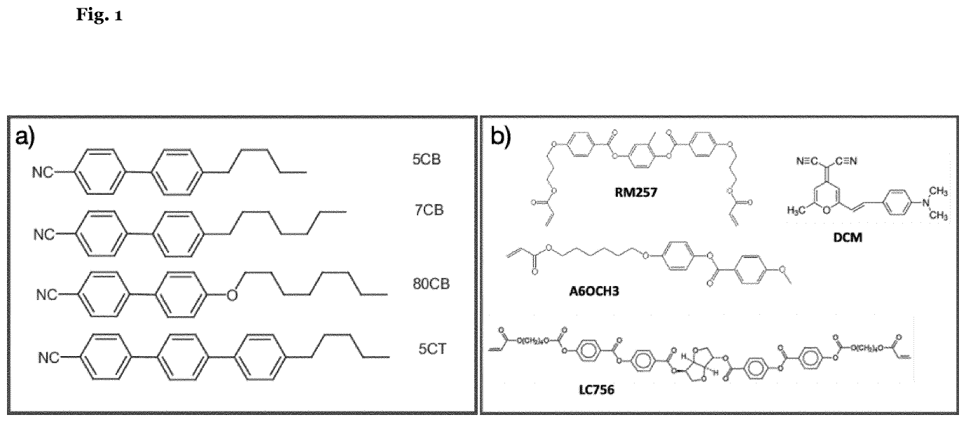

For the CSR to show primary RGB colours in reflection, the CSR mixture is made using the following chemical components: a liquid crystal mixture E7, a chiral dopant (LC756), a difunctional reactive mesogen (RM257), a monofunctional monomer (A6OCH3), and a photoinitiator (Irgacure 651). The chemical structure of liquid crystal mixture E7 is shown in FIG. 1(a). The chemical structures of monomers are shown in FIG. 1(b).

The period of the helix of the CLC (i.e. the pitch of the helix) can be tuned by the chiral dopant concentration. The concentration of the chiral dopant is different for each colour (e.g. R, G and B). It should be noted that the concentration of chiral dopant CLC precursor mixture may also be tuned so that the reflector reflects outside the visible band (e.g. in the infrared (IR) or the ultraviolet (UV) band).

The precursor mixture was heated to dissolution at 80° C. for 30 min and cooled to room temperature before the CSR production.

The CSR production process is known in the art (see e.g. J. Fan, “Light-directing omnidirectional circularly polarized reflection from liquid-crystal,” Angew. Chemie-Int. Ed, vol. 54, p. 2160, 2015 for CLC droplets and patent LU101463 for CLC shells). The CSRs may be droplet or shells and are of spherical shape. The CSRs may have a radial cholesteric helix orientation.

FIG. 2(a) shows the R, G and B-CSRs (from left to right, respectively) that are assembled on a water-air interface inside glass vials, giving rise to a region with distinct color when imaged using ambient lighting conditions.

The RGB cholesteric liquid crystal reflectors having different retroreflection peak wavelengths may be composed such that the mixture combines, to the naked human eye, into a so-called composite colour, in the sense that the color seen by the eye is the result of the proportion of R, G and B-CSRs in the mixture. An example is provided in FIG. 2(b), where R, G and B-CSRs were mixed at 1:1:1 proportion, yielding a white appearance to the naked eye.

The R, G and B CSRs may be affixed on a surface and covered with a binder as shown in FIG. 2(c). The binder which was used is transparent (Norland Optical Adhesive “NOA”). The CSRs are embedded in the matrix of solidified binder. The arrangement of CSRs is thus fixed.

A peculiarity of color provided by the CSR is the dependence on angles of illumination and observation according to Bragg's law, ×=npcosθ, where n is the average refractive index of the cholesteric material, A is the reflected wavelength, p is the pitch (period) of the cholesteric helix, and θ is the angle of incidence (the angle between illumination and observation directions is 2θ). Therefore, if the CSR is illuminated by light along directions other than the observation direction, the observer sees blue-shifted reflections (shorter wavelength) compared to the retroreflection peak wavelength. Therefore, as expected, the reflected colour of the R, G and B-CSRs are blue-shifted when the observation angle is different from the illumination incident angle. This effect has no visible consequence for B-CSRs since the blue-shifted reflections enter the UV region and are thus detected by naked human eyes.

In order to mitigate the blue-shifted reflections mixing in with the red and green appearance of the corresponding CSRs, and to obtain saturated colors, colorants (e.g. pigments or dyes) are provided in the precursor mixtures from which the CSRs are made. These colorants absorb the blue shifted reflections while they enhance reflections in the appropriate wavelength range. The chemical structures of an exemplary dye (DCM-orange) is shown in FIG. 1(b).

Similar to standard printing technologies, at least four types of CSRs may be used, each producing a different color. The key (K) is provided by CSRs reflecting outside the visible spectrum (K-CSRs—e.g. having a retroreflection peak wavelength of approximately 380 nm) and including a colorant absorbing all visible light wavelengths (e.g carbon black). The K-CSRs thus show no visible color to the human eye, but a read-out device with ‘black-light’ illumination, as used in UV devices for revealing water marks of money bills, will reveal the K-CSRs.

It should be noted that colour spaces other than RGBK are of course acceptable (such as e.g. CMYK).

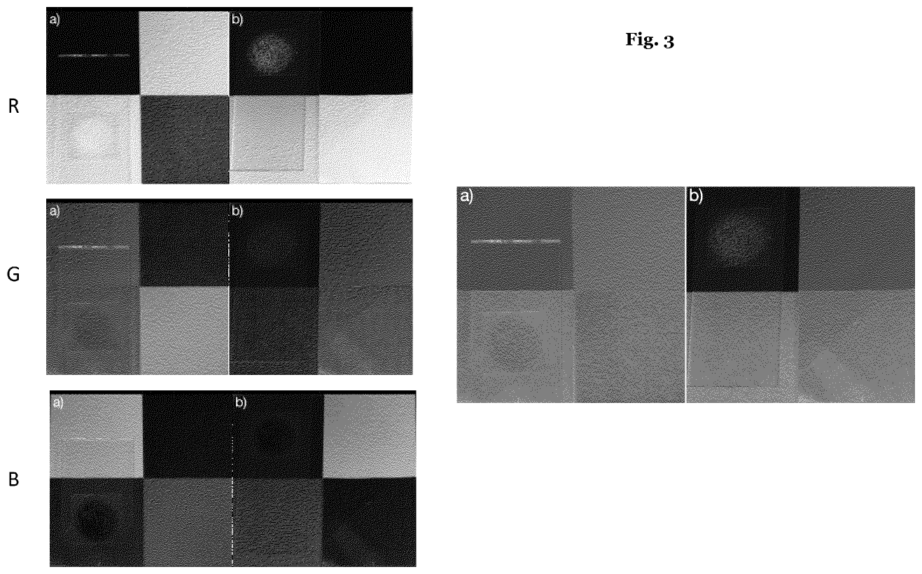

With reference to FIG. 3, an arrangement of CSRs having a retroreflection peak wavelength giving an orange color is shown, the CSRs being doped with an orange dye. The arrangement of CSRs is sandwiched between two glass slides and placed on top of a multicolored paper. In particular, the paper comprises four patches having different colours: blue (top left), red (top right), orange (bottom left) and green (bottom right) for (a) and black (top left), blue (top right), magenta (bottom left) and orange (bottom right) for (b). In FIG. 3(a), the CSRs are placed on top of a colour-matching patch (orange-bottom left). The CSRs cannot be distinguished from the background: they are camouflaged. In, FIG. 3(b), the same arrangement of CSRs is placed on top of a black background (top left) and can be seen, the CSRs providing an orange colour on top of the black patch.

It will be appreciated that virtually any colour may be matched with (preferably colorant-doped) CSRs, either by tuning the pitch of the helix or by mixing R, G, B and K so that the target colour is obtained. The CSRs so obtained are hidden from plain eyesight due to the colour-matching. In practice, such CSRs are equivalent to standard colorants used in paints or inks and fulfill the same function.

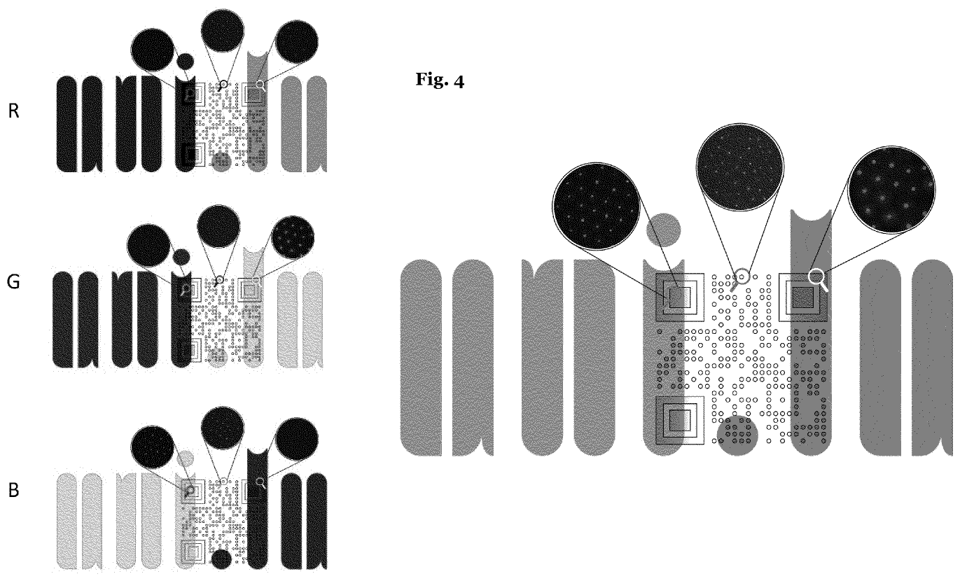

A logo of the University of Luxembourg (′uni.lu′) is shown in FIG. 4. The first part of the logo ‘uni’ is red and the second part ‘.lu’ is blue. The logo thus comprises a plurality of patches having different colours. In order to provide a camouflaged tag, the colours of the CSRs should be matched with the different patches (background). As shown in FIG. 4, red-matching CSRs are used for red patches and blue-matching CSRs are used for blue patches. It should be noted that a mixture of R, G and B-CSRs may also be used. As also shown in FIG. 4, the CSRs are also placed on a white patch (white background). The R, G and B-CSRs are mixed in a 1:1:1 proportion so that the mixing provides a white colour (addition of the R, G and B in (substantially the same proportion). K-CSRs may also be used, if needed for color-matching or tuning of greytones.

As shown in FIG. 4, complex designs may be achieved using CSRs such as QR codes, undetectable by humans since they have been applied (e.g. printed) using a color matching the background of each patches. The complex designs may be applied by printing, e.g. using pad or screen printing technology, with inks comprising CSRs. The solid black lines are used for highlighting the surfaces comprising CSRs, these lines are of course not there in reality.

The embodiment depicted in FIG. 4 allows for providing information on two distinct scales, both being camouflaged in the décor of the article. The first of the two scales is the (microscopic, individual) arrangement of the CSRs forming a PUF, thereby providing a unique fingerprint to the article. The second of the two scales is the QR code formed by the (macroscopic, collective) arrangement of the CSRs (delimited by the solid black lines in FIG. 4). Of course, any other kind of serialisation code is contemplated such as a bar code. Alphanumeric symbols may also be encoded in the second of the two scales of information. This allows for, simultaneously, 1) authenticating the article as well as the serialisation code or any information encoded into the code (e.g alphanumeric symbols) and 2) providing information to the user with the serialisation code (e.g. a link to a website). In case the tag is positively authenticated, the user knows that said information has not been tampered with by a third party.

It is worthwhile noting that the tag, in particular the second of the two scales of information (serialisation codes, alphanumeric symbols, etc.), may be located where it would have been out of the question with prior art solution. This is indeed the case since the tags blend in the décor. The tag, in particular the arrangement of CSRs, is covert.

The arrangement of the CSRs may have many degrees of freedom providing the unique fingerprint (PUF), such as the position of each CSR, the respective colors of the arranged CSRs, the size of the respective arranged CSRs, the reflection polarization (left or right handed helix of the CSRs), the use of CSR droplets and/or shells. Also, the exact structure of the CSRs depends on physical factors introduced during manufacture (e.g. defects), which are unpredictable. In the simplest case, only the position of the CSRs contributes to the unique fingerprint.

It is worthwhile noting that, the arrangement of CSRs may be added on an existing article, e.g. by means of a binder. The CSRs may be dispersed in the binder and then the mixture applied on a surface of the article, or the CSRs may be applied first on the surface of the article and then covered by the binder. The binder may be UV-curable. A step of curing the binder is further implemented in order for the binder to provide a matrix in which the CSRs are embedded. Other standard techniques of curing are also contemplated such as evaporating the solvent of the binder. The arrangement of CSRs so obtained are thereby integral to the article and do not modify the appearance of the article as they are camouflaged and provide an additional exposed layer to the article. In an embodiment, the arrangement of the CSRs may be provided during production of the article, thereby forming an integral part of the article by design.

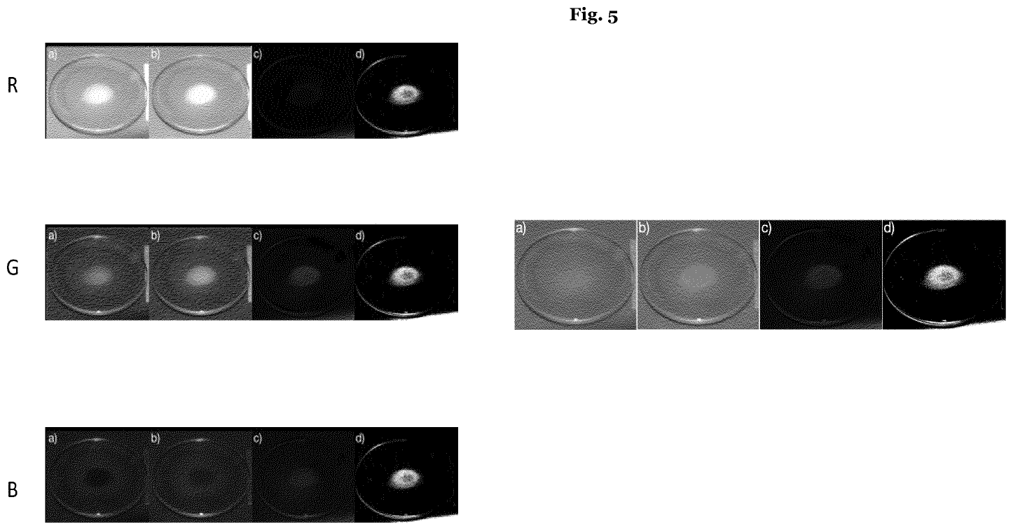

FIG. 5 illustrates a method for reading the tag comprising the arrangement of CSRs and authenticating the article. The method generally comprises probing the tag with an electromagnetic radiation for example with ambient light, a flash, one or more of the standardized CIE illuminants and/or a blacklight. In a second step, the electromagnetic response of the tag to the electromagnetic radiation is sensed. This may be achieved by taking photos obtained through right- and left-handed polarizers. An example of image obtained through left- and right-handed polarizers is provided in FIG. 5(a) and FIG. 5(b) respectively. FIG. 5(c) shows the subtraction between the two images (a) and (b) wherein the arrangement of CSRs stands out (the non-CSR signal is—at least substantially—removed). FIG. 5(d) shows a monochromatic representation depicting the CSRs in white. The method further comprises comparing the sensed response to an expected response so as to authenticate the sensed tag. For example, the monochromatic representation may be compared to an expected monochromatic representation of the response. If the expected and sensed monochromatic representation match, the tag (and thus the article) is validated, and the article is positively authenticated. Conversely, if the same do not match, the article is rejected. Preferably, the expected response is stored in a database, as will be described below.

On the production side of the tag, a certification authority (e.g the manufacturer of the article or any trusted party) probes and senses the tag in the same way as described in the present document. The response of the tag is stored in a certification infrastructure, as a reference. For example, the response may be stored in a database.

Any party looking for authenticating an article may compare the response of the tag with the expected response retrieved from the certification authority (e.g. the database).

While specific embodiments have been described herein in detail, those skilled in the art will appreciate that various modifications and alternatives to those details could be developed in light of the overall teachings of the disclosure. Accordingly, the particular arrangements disclosed are meant to be illustrative only and not limiting as to the scope of the invention, which is to be given the full breadth of the appended claims and any and all equivalents thereof.

1. An article having a décor provided by one or more exposed layers, comprising a tag integrated in the one or more exposed layers yet camouflaged in the décor to the naked human eye, the tag comprising an arrangement of cholesteric liquid crystal spherical reflectors.

2. The article as claimed in claim 1, wherein the arrangement provides a physical unclonable function, thereby providing a unique fingerprint to the article.

3. The article as claimed in claim 1, wherein the décor includes one or more coloured patches, each patch having a colour, wherein the cholesteric liquid crystal spherical reflectors are localized in one or more of the coloured patches and wherein the cholesteric liquid crystal spherical reflectors localized in a coloured patch are colour-matched with the colour of that coloured patch.

4. The article as claimed in claim 3, wherein the cholesteric liquid crystal spherical reflectors localized in a coloured patch are colour-matched with the colour of that coloured patch in that the cholesteric liquid crystal spherical reflectors have a retroreflection peak wavelength corresponding to the colour of the coloured patch.

5. The article as claimed in claim 3, wherein the cholesteric liquid crystal spherical reflectors localized in a coloured patch are colour-matched with the colour of that coloured patch in that a multiplicity of cholesteric liquid crystal spherical reflectors having different retroreflection peak wavelengths is provided in that patch, the multiplicity being composed such that a mixture of the retroreflection peak wavelengths combines, to the naked human eye, into a colour corresponding to the colour of the coloured patch.

6. The article as claimed in claim 1, wherein the cholesteric liquid crystal spherical reflectors are doped with a colorant so as to at least partially absorb reflections of the spherical reflectors, in the visible spectrum, that are blue shifted with respect to the spherical reflectors respective retroreflection peaks.

7. The article as claimed in claim 1, wherein the arrangement of cholesteric liquid crystal spherical reflectors comprises at least two of: cholesteric liquid crystal spherical reflectors having a retroreflection peak comprised in the range from 625 nm to 750 nm, comprised in the range from 500 nm to 565 nm and comprised in the range from 450 nm to 485 nm.

8. The article as claimed in claim 1, the arrangement of cholesteric liquid crystal spherical reflectors comprises cholesteric liquid crystal spherical reflectors having a retroreflection peak comprised outside of the visible spectrum.

9. The article as claimed in claim 1, wherein the tag comprises a binder in which the arrangement of cholesteric liquid crystal spherical reflectors is embedded.

10. The article as claimed in claim 9, wherein the binder is transparent or at least semi-transparent.

11. The article as claimed in claim 9, the binder having a melting temperature, the melting temperature being selected such that it is equal to a predefined maximal storing temperature of the article.

12. The article as claimed in claim 1, wherein the tag comprises at least one of: a serialisation code e.g. a QR code or a barcode, and alphanumeric symbols.

13. The article as claimed in claim 1, the article being an authenticable article, wherein an expected response of the arrangement of cholesteric liquid crystal spherical reflectors of the tag with respect to an electromagnetic stimulus is stored in a database.

14. A method for providing an authenticable article, comprising: probing a tag an article having a décor provided by one or more exposed layers, comprising a tag integrated in the one or more exposed layers yet camouflaged in the décor to the naked human eye, the tag comprising an arrangement of cholesteric liquid crystal spherical reflectors, with an electromagnetic radiation;
sensing the tag electromagnetic response to the electromagnetic radiation; and
storing the sensed response in a database.

15. The method as claimed in claim 14, wherein the sensing of the tag comprises taking two digital pictures, the first of the two digital pictures being obtained through a left-handed circular polarizer and the second of the two digital pictures being obtained through a right-handed circular polarizer, the storing of the sensed response comprises storing at least one of: both the digital images obtained through the left-handed circular polarizer and the right-handed circular polarizer and the difference between the digital images obtained through the left-handed circular polarizer and the right-handed circular polarizer.

16. (canceled)

17. (canceled)

18. A communication method comprising:
retrieving, from a database, an expected electromagnetic response of a tag of an article to be authenticated, the article having a décor provided by one or more exposed layers, comprising a tag integrated in the one or more exposed layers yet camouflaged in the décor to the naked human eye, the tag comprising an arrangement of cholesteric liquid crystal spherical reflectors; and
comparing an electromagnetic response sensed from the tag of the article to be authenticated with the expected electromagnetic response so as to authenticate the sensed tag.
